(19) United States
(12) Patent Application Publication
(10) Pub. No.: US 2025/0103991 A1
(43) Pub. Date: Mar. 27, 2025

(54) ANOMALY DETERMINATION METHOD AND PRODUCTION MANAGEMENT SYSTEM

(71) Applicant: Panasonic Intellectual Property Management Co., Ltd., Osaka (JP)

(72) Inventors: Yuta SHIMAZAKI, Osaka (JP); Akira MINEGISHI, Osaka (JP)

(21) Appl. No.: 18/727,966

(22) PCT Filed: Jan. 13, 2023
(86) PCT No.: PCT/JP2023/000843

§ 371 Date: Jul. 10, 2024

(30) Foreign Application Priority Data
Jan. 19, 2022 (JP) 2022-006313

(51) Int. Cl. G06Q 10/0633; G06Q 50/04

(52) U.S. Cl. CPC G06Q 10/0633; G06Q 50/04

(57) ABSTRACT

An anomaly determination method, in a production management system that manages a production line including first, second, and third production devices, includes: obtaining, from among first, second, and third operating status data of the first, second, and third production devices, respectively, at least the first and third operating status data; when it is determined that the second operating status data was not obtained, predicting a dummy operation timepoint corresponding to a planned production quantity of the second production device, and generating dummy operating status data including the planned production quantity and the dummy operation timepoint; performing anomaly determination processing on production processes as a whole based on the first and third operating status data and the dummy operating status data; and outputting determination result information representing a result of the anomaly determination processing to display the determination result information on a display device included in the production management system.

### CROSS-REFERENCE OF RELATED APPLICATIONS

This application is the U.S. National Phase under 35 U.S.C. § 371 of International Patent Application No. PCT/JP2023/000843, filed on Jan. 13, 2023, which in turn claims the benefit of Japanese Patent Application No. 2022-006313, filed on Jan. 19, 2022, the entire disclosure of which Applications are incorporated by reference herein.

### TECHNICAL FIELD

The present disclosure relates to an anomaly determination method and a production management system.

### BACKGROUND ART

In production sites such as factories, in order to promptly deal with anomalies when they occur, the operating status of the equipment must be appropriately managed. Using machine learning (AI) in the management of the states of various devices such as equipment is being considered. When using machine learning to manage states, if input data that exceeds the allowable range is input, or if no input data is input at all, it becomes impossible to accurately determine whether an anomaly has occurred.

In view of this, for example, Patent Literature (PTL) 1 discloses a state determination device that performs guard processing to bring input data closer to the allowable range when data that falls outside the allowable range is input. PTL 2 discloses a communication method for an equipment operation monitoring device that transmits data using two types of communication methods so as to avoid data loss.

### CITATION LIST

### Patent Literature

[PTL 1] Japanese Unexamined Patent Application Publication No. 2021-55668
[PTL 2] Japanese Unexamined Patent Application Publication No. 2000-134680

### SUMMARY OF INVENTION

### Technical Problem

However, with the state determination device disclosed in PTL 1, guard processing cannot be performed unless input data is input. While the communication method disclosed in PTL 2 may be able to reduce the possibility of data loss, when data loss does occur, it is not possible to perform anomaly determination.

In view of the above technical problems, the present disclosure provides an anomaly determination method and a production management system that can determine whether an anomaly has occurred with high accuracy.

### Solution to Problem

An anomaly determination method according to one aspect of the present disclosure is a method in a production management system that manages a production line including a first production device corresponding to a first process, a second production device corresponding to a second process following the first process, and a third production device corresponding to a third process following the second process, and includes: from among (i) first operating status data including a first production quantity of the first production device and a first operation timepoint corresponding to each production in the first production device, (ii) second operating status data including a second production quantity of the second production device and a second operation timepoint corresponding to each production in the second production device, and (iii) third operating status data including a third production quantity of the third production device and a third operation timepoint corresponding to each production in the third production device, obtaining at least (i) the first operating status data and (iii) the third operating status data via a network; when it is determined that the second operating status data was not obtained based on the first operation timepoint and the third operation timepoint, predicting a dummy operation timepoint corresponding to a planned production quantity of the second production device based on the first operating status data and the third operating status data, and generating dummy operating status data that corresponds to the second operating status data and includes the planned production quantity and the dummy operation timepoint; based on the first operating status data, the third operating status data, and the dummy operating status data, performing anomaly determination processing on production processes, including processes from the first process to the third process, as a whole; and outputting determination result information to display the determination result information on a display device included in the production management system, the determination result information representing a result of the anomaly determination processing.

An anomaly determination method according to another aspect of the present disclosure is a method in a production management system that manages a production line including a first production device corresponding to a first process, a second production device corresponding to a second process following the first process, and a third production device corresponding to a third process following the second process, and includes: obtaining, via a network, (i) first operating status data including a first production quantity of the first production device and a first operation timepoint corresponding to each production in the first production device and (ii) third operating status data including a third production quantity of the third production device and a third operation timepoint corresponding to each production in the third production device; predicting a dummy operation timepoint corresponding to a planned production quantity of the second production device based on the first operating status data and the third operating status data, and generating dummy operating status data including the planned production quantity and the dummy operation timepoint; based on the first operating status data, the third operating status data, and the dummy operating status data, performing anomaly determination processing on production processes, including processes from the first process to the third process, as a whole; and outputting determination result information to display the determination result information on a display device included in the production management system, the determination result information representing a result of the anomaly determination processing.

An anomaly determination method according to another aspect of the present disclosure is a method in a production management system that manages a production line including a first production device corresponding to a first process and a second production device corresponding to a second process, the second process being a final process and following the first process, and includes: from among (i) first operating status data including a first production quantity of the first production device and a first operation timepoint corresponding to each production in the first production device and (ii) second operating status data including a second production quantity of the second production device and a second operation timepoint corresponding to each production in the second production device, obtaining at least the first operating status data via a network; when it is determined that the second operating status data was not obtained based on the first operation timepoint, predicting a dummy operation timepoint corresponding to a planned production quantity of the second production device based on the first operating status data, and generating dummy operating status data that corresponds to the second operating status data and includes the planned production quantity and the dummy operation timepoint; based on the first operating status data and the dummy operating status data, performing anomaly determination processing on production processes, including the first process and the second process, as a whole; and outputting determination result information to display the determination result information on a display device included in the production management system, the determination result information representing a result of the anomaly determination processing.

An anomaly determination method according to another aspect of the present disclosure is a method in a production management system that manages a production line including a first production device corresponding to a first process and a second production device corresponding to a second process following the first process, the first process being an initial process, the anomaly determination method including: from among (i) first operating status data including a first production quantity of the first production device and a first operation timepoint corresponding to each production in the first production device and (ii) second operating status data including a second production quantity of the second production device and a second operation timepoint corresponding to each production in the second production device, obtaining at least the second operating status data via a network; when it is determined that the first operating status data was not obtained based on the second operation timepoint, predicting a dummy operation timepoint corresponding to a planned production quantity of the first production device based on the second operating status data, and generating dummy operating status data that corresponds to the first operating status data and includes the planned production quantity and the dummy operation timepoint; based on the dummy operating status data and the second operating status data, performing anomaly determination processing on production processes, including the first process and the second process, as a whole; and outputting determination result information to display the determination result information on a display device included in the production management system, the determination result information representing a result of the anomaly determination processing.

A production management system according to one aspect of the present disclosure is a system that manages a production line including a first production device corresponding to a first process, a second production device corresponding to a second process following the first process, and a third production device corresponding to a third process following the second process, and includes: from among (i) first operating status data including a first production quantity of the first production device and a first operation timepoint corresponding to each production in the first production device, (ii) second operating status data including a second production quantity of the second production device and a second operation timepoint corresponding to each production in the second production device, and (iii) third operating status data including a third production quantity of the third production device and a third operation timepoint corresponding to each production in the third production device, obtaining at least (i) the first operating status data and (iii) the third operating status data via a network; when it is determined that the second operating status data was not obtained based on the first operation timepoint and the third operation timepoint, predicting a dummy operation timepoint corresponding to a planned production quantity of the second production device based on the first operating status data and the third operating status data, and generating dummy operating status data that corresponds to the second operating status data and includes the planned production quantity and the dummy operation timepoint; based on the first operating status data, the third operating status data, and the dummy operating status data, performing anomaly determination processing on production processes, including processes from the first process to the third process, as a whole; and outputting determination result information to display the determination result information on a display device included in the production management system, the determination result information representing a result of the anomaly determination processing.

A production management system according to another aspect of the present disclosure is a system that manages a production line including a first production device corresponding to a first process, a second production device corresponding to a second process following the first process, and a third production device corresponding to a third process following the second process, and includes: obtaining, via a network, (i) first operating status data including a first production quantity of the first production device and a first operation timepoint corresponding to each production in the first production device and (ii) third operating status data including a third production quantity of the third production device and a third operation timepoint corresponding to each production in the third production device; predicting a dummy operation timepoint corresponding to a planned production quantity of the second production device based on the first operating status data and the third operating status data, and generating dummy operating status data including the planned production quantity and the dummy operation timepoint; based on the first operating status data, the third operating status data, and the dummy operating status data, performing anomaly determination processing on production processes, including processes from the first process to the third process, as a whole; and outputting determination result information to display the determination result information on a display device included in the production management system, the determination result information representing a result of the anomaly determination processing.

Moreover, one aspect of the present disclosure can be realized as a program for causing a computer to execute the anomaly determination methods described above. Alternatively, one aspect of the present disclosure can be realized as a non-transitory computer-readable recording medium having such a program recorded thereon.

### Advantageous Effects of Invention

The techniques of the present disclosure can determine whether an anomaly has occurred with high accuracy.

### BRIEF DESCRIPTION OF DRAWINGS

FIG. 1 illustrates a configuration of a production management system according to an embodiment of the present disclosure.

FIG. 2 is a block diagram illustrating the functional configuration of a production management system according to an embodiment of the present disclosure.

FIG. 3 illustrates one example of production log data.

FIG. 4 is a sequence diagram illustrating operations performed by a production management system according to an embodiment of the present disclosure.

FIG. 5 is a flowchart illustrating operations performed by a production management system according to an embodiment of the present disclosure.

FIG. 6 is a flowchart illustrating a process for generating dummy operating status data.

FIG. 7 illustrates the relationship between the trained probability distribution, which is a production model of a single production line, and the anomaly degree.

FIG. 8 is a flowchart illustrating cause identification processing for identifying the cause of an anomaly.

FIG. 9 is a flowchart illustrating a process for generating a machine learning model.

FIG. 10 illustrates an example of dummy operating status data generated when operating status data of an intermediate process is missing.

FIG. 11 illustrates input data and output data related to a process for generating dummy operating status data.

FIG. 12 illustrates an example of dummy operating status data generated when operating status data for the initial process is missing.

FIG. 13 illustrates an example of dummy operating status data generated when operating status data for the final process is missing.

FIG. 14 illustrates an example of dummy operating status data generated in place of operating status data that is not planned to be obtained.

FIG. 15 illustrates examples of displaying determination results in a production management system according to an embodiment of the present disclosure.

### DESCRIPTION OF EMBODIMENTS

### Overview of Present Disclosure

An anomaly determination method according to one aspect of the present disclosure is a method in a production management system that manages a production line including a first production device corresponding to a first process, a second production device corresponding to a second process following the first process, and a third production device corresponding to a third process following the second process, and includes: from among (i) first operating status data including a first production quantity of the first production device and a first operation timepoint corresponding to each production in the first production device, (ii) second operating status data including a second production quantity of the second production device and a second operation timepoint corresponding to each production in the second production device, and (iii) third operating status data including a third production quantity of the third production device and a third operation timepoint corresponding to each production in the third production device, obtaining at least (i) the first operating status data and (iii) the third operating status data via a network; when it is determined that the second operating status data was not obtained based on the first operation timepoint and the third operation timepoint, predicting a dummy operation timepoint corresponding to a planned production quantity of the second production device based on the first operating status data and the third operating status data, and generating dummy operating status data that corresponds to the second operating status data and includes the planned production quantity and the dummy operation timepoint; based on the first operating status data, the third operating status data, and the dummy operating status data, performing anomaly determination processing on production processes, including processes from the first process to the third process, as a whole; and outputting determination result information to display the determination result information on a display device included in the production management system, the determination result information representing a result of the anomaly determination processing.

As described above, in a production line including a first production device, a second production device, and a third production device, when any one of these production devices malfunctions, the overall operation rate decreases and the production quantity decreases. When anomaly determination processing is performed for each individual process and a cause is determined for each process, the determination takes a very long time, and a large amount of memory is required.

However, in the case of a production line in which the first production device, the second production device, and the third production device are connected, by performing anomaly determination processing on the production processes, including the first process, the second process, and the third process, as a whole, it is possible to identify the process in which an anomaly occurred. This also reduces the amount of processing, whereby determination can be performed in a shorter period of time.

However, assuming there is first operating status data corresponding to the first process, second operating data corresponding to the second process, and third operating status data corresponding to the third process, if any of the data is missing, it becomes impossible to perform anomaly determination processing on the production processes as a whole. Such data loss may occur, for example, due to the status of the network over which the first operating status data, the second operating status data, and the third operating status data is transmitted and received.

Therefore, in the anomaly determination method according to one aspect of the present disclosure, as described above, when it is determined that data loss has occurred, corresponding dummy operating status data is generated. This makes it possible to continue anomaly determination processing on the production processes as a whole even when data loss has occurred.

The dummy operating status data is generated based on the operating status data of the processes immediately preceding and following the process in which the data loss occurred. For example, the number of products produced per operating time in the process in which the data loss occurred is estimated based on the operating status data for the preceding and following processes.

This makes it possible to continue anomaly determination processing on the production processes as a whole and determine whether an anomaly has occurred in a short amount of time without compromising accuracy, even when operating status data loss has occurred in any of the processes due to network conditions or the like.

For example, the outputting of the determination result information may include outputting that the anomaly determination processing was performed using the dummy operating status data in the second process.

This makes it possible to notify that anomaly determination processing was performed using dummy operating status data, thereby making it clear that there was a problem with data transfer, leading to improvements.

For example, the anomaly determination processing may determine presence or absence of an anomaly in the production processes as a whole based on a total production quantity during a total operating time for an entirety of the production processes.

This makes it possible to accurately determine whether an anomaly occurred in the production processes as a whole.

For example, for each process among all the production processes, the anomaly determination processing may determine presence or absence of an anomaly in the process based on a production quantity during an operating time of the process.

This makes it possible to accurately determine where an anomaly has occurred in each process and accurately identify the cause of the anomaly.

For example, the result of the anomaly determination processing may include that there is no anomaly in the production processes.

This makes it possible to clearly determine whether or not an anomaly is present.

For example, the first production device, the second production device, and the third production device may be connected by a belt conveyor in the production line.

A production management system according to one aspect of the present disclosure is a system that manages a production line including a first production device corresponding to a first process, a second production device corresponding to a second process following the first process, and a third production device corresponding to a third process following the second process, and includes: from among (i) first operating status data including a first production quantity of the first production device and a first operation timepoint corresponding to each production in the first production device, (ii) second operating status data including a second production quantity of the second production device and a second operation timepoint corresponding to each production in the second production device, and (iii) third operating status data including a third production quantity of the third production device and a third operation timepoint corresponding to each production in the third production device, obtaining at least (i) the first operating status data and (iii) the third operating status data via a network; when it is determined that the second operating status data was not obtained based on the first operation timepoint and the third operation timepoint, predicting a dummy operation timepoint corresponding to a planned production quantity of the second production device based on the first operating status data and the third operating status data, and generating dummy operating status data that corresponds to the second operating status data and includes the planned production quantity and the dummy operation timepoint; based on the first operating status data, the third operating status data, and the dummy operating status data, performing anomaly determination processing on production processes, including processes from the first process to the third process, as a whole; and outputting determination result information to display the determination result information on a display device included in the production management system, the determination result information representing a result of the anomaly determination processing.

This makes it possible to achieve the same advantageous effects as the anomaly determination method described above. In other words, this makes it possible to continue anomaly determination processing on the production processes as a whole and determine whether an anomaly has occurred in a short amount of time without compromising accuracy, even when operating status data loss as occurred in any of the processes.

An anomaly determination method according to another aspect of the present disclosure is a method in a production management system that manages a production line including a first production device corresponding to a first process, a second production device corresponding to a second process following the first process, and a third production device corresponding to a third process following the second process, and includes: obtaining, via a network, (i) first operating status data including a first production quantity of the first production device and a first operation timepoint corresponding to each production in the first production device and (ii) third operating status data including a third production quantity of the third production device and a third operation timepoint corresponding to each production in the third production device; predicting a dummy operation timepoint corresponding to a planned production quantity of the second production device based on the first operating status data and the third operating status data, and generating dummy operating status data including the planned production quantity and the dummy operation timepoint; based on the first operating status data, the third operating status data, and the dummy operating status data, performing anomaly determination processing on production processes, including processes from the first process to the third process, as a whole; and outputting determination result information to display the determination result information on a display device included in the production management system, the determination result information representing a result of the anomaly determination processing.

This makes it possible to generate dummy data in place of data that is not obtained, not only in cases of data loss, but also in cases where there are no plans to obtain the data. Therefore, anomaly determination processing can be performed for the production processes as a whole, and where an anomaly has occurred can be determined in a short amount of time without compromising accuracy.

For example, the outputting of the determination result information may include outputting that the anomaly determination processing was performed using the dummy operating status data in the second process.

This makes it possible to notify that anomaly determination processing was performed using dummy operating status data, thereby making it clear that there was a problem with data transfer, leading to improvements.

A production management system according to another aspect of the present disclosure is a system that manages a production line including a first production device corresponding to a first process, a second production device corresponding to a second process following the first process, and a third production device corresponding to a third process following the second process, and includes: obtaining, via a network, (i) first operating status data including a first production quantity of the first production device and a first operation timepoint corresponding to each production in the first production device and (ii) third operating status data including a third production quantity of the third production device and a third operation timepoint corresponding to each production in the third production device; predicting a dummy operation timepoint corresponding to a planned production quantity of the second production device based on the first operating status data and the third operating status data, and generating dummy operating status data including the planned production quantity and the dummy operation timepoint; based on the first operating status data, the third operating status data, and the dummy operating status data, performing anomaly determination processing on production processes, including processes from the first process to the third process, as a whole; and outputting determination result information to display the determination result information on a display device included in the production management system, the determination result information representing a result of the anomaly determination processing.

This makes it possible to achieve the same advantageous effects as the anomaly determination method described above. Stated differently, anomaly determination processing can be performed for the production processes as a whole, and whether an anomaly has occurred can be determined in a short amount of time without compromising accuracy, not only in cases of data loss, but also in cases where there are no plans to obtain the data.

An anomaly determination method according to another aspect of the present disclosure is a method in a production management system that manages a production line including a first production device corresponding to a first process and a second production device corresponding to a second process, the second process being a final process and following the first process, and includes: from among (i) first operating status data including a first production quantity of the first production device and a first operation timepoint corresponding to each production in the first production device and (ii) second operating status data including a second production quantity of the second production device and a second operation timepoint corresponding to each production in the second production device, obtaining at least the first operating status data via a network; when it is determined that the second operating status data was not obtained based on the first operation timepoint, predicting a dummy operation timepoint corresponding to a planned production quantity of the second production device based on the first operating status data, and generating dummy operating status data that corresponds to the second operating status data and includes the planned production quantity and the dummy operation timepoint; based on the first operating status data and the dummy operating status data, performing anomaly determination processing on production processes, including the first process and the second process, as a whole; and outputting determination result information to display the determination result information on a display device included in the production management system, the determination result information representing a result of the anomaly determination processing.

This makes it possible to continue anomaly determination processing on the production processes as a whole and determine whether an anomaly has occurred in a short amount of time without compromising accuracy, even when operating status data loss has occurred in the final process among all production processes.

For example, the outputting of the determination result information may include outputting that the anomaly determination processing was performed using the dummy operating status data in the second process.

This makes it possible to notify that anomaly determination processing was performed using dummy operating status data, thereby making it clear that there was a problem with data transfer, leading to improvements.

An anomaly determination method according to another aspect of the present disclosure is a method in a production management system that manages a production line including a first production device corresponding to a first process and a second production device corresponding to a second process following the first process, the first process being an initial process, the anomaly determination method including: from among (i) first operating status data including a first production quantity of the first production device and a first operation timepoint corresponding to each production in the first production device and (ii) second operating status data including a second production quantity of the second production device and a second operation timepoint corresponding to each production in the second production device, obtaining at least the second operating status data via a network; when it is determined that the first operating status data was not obtained based on the second operation timepoint, predicting a dummy operation timepoint corresponding to a planned production quantity of the first production device based on the second operating status data, and generating dummy operating status data that corresponds to the first operating status data and includes the planned production quantity and the dummy operation timepoint; based on the dummy operating status data and the second operating status data, performing anomaly determination processing on production processes, including the first process and the second process, as a whole; and outputting determination result information to display the determination result information on a display device included in the production management system, the determination result information representing a result of the anomaly determination processing.

This makes it possible to continue anomaly determination processing on the production processes as a whole and determine whether an anomaly has occurred in a short amount of time without compromising accuracy, even when operating status data loss has occurred in the initial process among all production processes.

For example, the outputting of the determination result information may include outputting that the anomaly determination processing was performed using the dummy operating status data in the first process.

This makes it possible to notify that anomaly determination processing was performed using dummy operating status data, thereby making it clear that there was a problem with data transfer, leading to improvements.

Hereinafter, one or more embodiments will be described in detail with reference to the drawings.

Each embodiment described below shows a general or specific example. The numerical values, shapes, materials, elements, the arrangement and connection of the elements, steps, order of the steps etc., indicated in the following embodiments are mere examples, and therefore do not intend to limit the present disclosure. Therefore, among elements in the following embodiments, those not recited in any of the independent claims are described as optional elements.

Note that the figures are schematic illustrations and are not necessarily precise depictions. Accordingly, the figures are not necessarily to scale. Moreover, in the figures, the same reference signs are used for elements that are essentially the same. Accordingly, duplicate description is omitted or simplified.

### Embodiment

### 1. Production Management System Overview

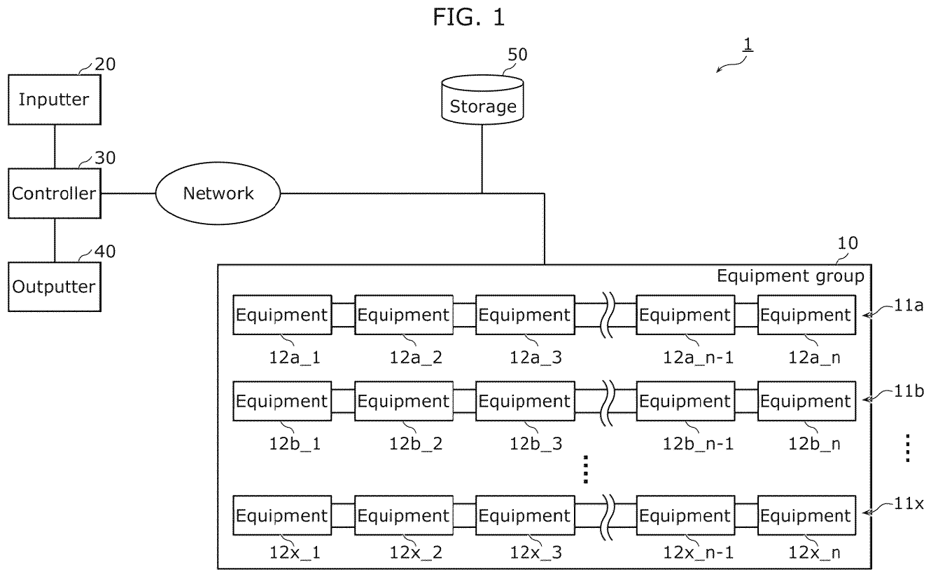

First, an overview of the production management system according to the present embodiment will be described with reference to FIG. 1.

FIG. 1 illustrates a configuration of production management system 1 according to the present embodiment. Production management system 1 illustrated in FIG. 1 is a system that manages a production line including a plurality of production devices. In the present embodiment, production management system 1 manages equipment group 10. Next, equipment group 10, which is the management target of production management system 1, will be described.

In FIG. 1, each production line and each unit of equipment is assigned with a unique reference sign for distinguishing between them, such as production lines 11a and 11b and equipment 12a_1, 12a_2, and 12b_1, but when there is no need to distinguish between them, in the following description, the production line or equipment may be simply referred to using their common base reference sign, such as production line 11 and equipment 12.

Equipment group 10 includes x production lines 11, where x is a natural number greater than or equal to one.

Each of the x production lines 11 includes n units of equipment 12, where n is a natural number greater than or equal to 2. Note that the number of units of equipment 12 included in one production line 11 may be different from the number of units of equipment 12 included in another production line 11. Each of the x production lines 11 produces a plurality of products. A single product is produced by sequentially performing a plurality of processes. The plurality of processes are, for example, component mounting, processing, assembly, and the like, but are not particularly limited. A product is produced by the n units of equipment 12 included in production line 11 sequentially executing processes assigned to each unit of equipment.

Equipment 12 is one example of a production device. For example, equipment 12 is a component mounting machine, an assembly device, a processing machine, or a conveyance device. In the example illustrated in FIG. 1, n units of equipment 12 are connected by belt conveyors. Products that are in the process of being produced are sequentially conveyed to the n units of equipment 12 by the belt conveyors.

Using production line 11a as one example, equipment 12a_1 is the production device corresponding to the initial process, equipment 12a_n is the production device corresponding to the final process, and equipment 12a_2 through 12a_n-1 are the production devices corresponding to the intermediate processes. Equipment 12a_1 through 12a_n produce a product by executing processes in this order.

Equipment 12 is provided with one or more sensors (not illustrated). The sensor measures values representing the operating status of equipment 12. For example, the sensor is an image sensor, an infrared sensor, a flow sensor, an ammeter, a pressure gauge, etc., but is not particularly limited. The sensor outputs the measurement results as operating status data of the corresponding equipment 12.

Equipment group 10 and production management system 1 are communicably connected via a network. The communication is wired communication or wireless communication, and the specific communication method used is not particularly limited.

Production management system 1 according to the present embodiment obtains operating status data output by sensors of each equipment 12 of equipment group 10, and determines whether an anomaly has occurred in production line 11 based on the obtained operating status data. Production management system 1 also identifies the cause of the anomaly in production line 11. More specifically, production management system 1 identifies, from among the n units of equipment 12 included in production line 11 in which an anomaly is determined to have occurred, equipment 12 that caused the anomaly and the type of anomaly. The determination of whether an anomaly has occurred and the identification of the cause of the anomaly are performed using a model generated by machine learning (i.e., a machine learning model). The machine learning model is a model that, when operating status data of each equipment 12 is input for each production line 11, outputs a determination result of whether an anomaly has occurred and, if an anomaly has occurred, the cause thereof.

The determination of whether an anomaly has occurred requires operating status data. However, depending on the status of the network, operating status data may be lost in some cases. In some instances, the intention to collect operating status data may be absent from the outset, such as when equipment 12 is not provided with a sensor.

Production management system 1 generates dummy operating status data (hereinafter “dummy data”) when the operating status data is not obtained due to loss or other factors. Production management system 1 can obtain a determination result of whether an anomaly has occurred and, if an anomaly has occurred, the cause thereof, by inputting input data including dummy data into the machine learning model. In this way, with production management system 1 of the present embodiment, even when operating status data is not obtained, anomaly determination processing on the processes of production line 11 as a whole can be continued, and whether an anomaly has occurred can be determined in a short time without compromising accuracy.

### 2. Production Management System Configuration

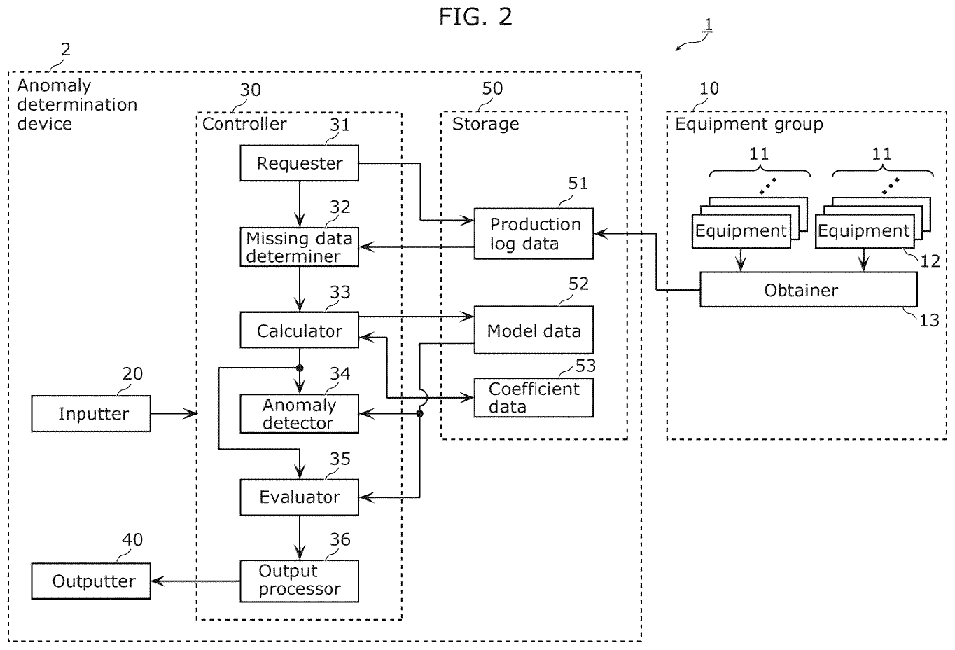

Next, the configuration of production management system 1 will be described in detail with reference to FIG. 2.

FIG. 2 is a block diagram illustrating the functional configuration of production management system 1 according to the present embodiment. As illustrated in FIG. 2, production management system 1 includes anomaly determination device 2 and obtainer 13. Anomaly determination device 2 includes inputter 20, controller 30, outputter 40, and storage 50.

Obtainer 13 obtains the operating status data of each unit of equipment 12 via a network. Obtainer 13 attempts to obtain the operating status data of all equipment 12 included in production line 11, but it is acceptable if obtainer 13 is not able to obtain some of the operating status data.

The operating status data includes a production quantity of each unit of equipment 12 and an operation timepoint corresponding to each production. The production quantity of equipment 12 is the quantity of products produced by equipment 12 during the operating period of equipment 12. Stated differently, the production quantity is the output quantity of products output by equipment 12.

Here, the product is an intermediate product, i.e., a product that is in the process of being produced, except when equipment 12 is the final unit of equipment in production line 11. The product produced by that final unit of equipment 12 is the final product of production line 11. Hereinafter, explanation will be given without distinguishing between an intermediate product and a final product, referring to both simply as “product”. Moreover, the material input into the initial unit of equipment 12 in production line 11 may also be referred to simply as “product” for convenience. The production quantity of equipment 12 may include not only the output quantity but also the input quantity of products input into equipment 12.

The operation timepoint corresponding to each production includes the start timepoint and end timepoint of the process for a single product by equipment 12. Alternatively, the operation timepoint corresponding to each production may include the start timepoint and end timepoint of the process on a lot-by-lot basis.

The operating status data may include other information related to equipment 12 and the product. For example, the operating status data may include identification information of production line 11, identification information of equipment 12 or the process, identification information of the lot, and type information of the product.

The operating status data may include information related to the stoppage of equipment 12. “Stoppage” includes a short-term standby (temporary stoppage) of the equipment sometimes called a “brief stop”, a stoppage due to a failure, and a planned stoppage for maintenance work. The information related to the stoppage includes a stoppage occurrence timepoint, a stoppage end timepoint, and a cause of the stoppage. The stoppage occurrence timepoint and the stoppage end timepoint can also be regarded as examples of the operation timepoint.

The information related to the stoppage may include at least one of a preceding process wait time or a subsequent process wait time. The preceding process wait time is the wait time of the equipment performing the current process between the immediately preceding process and the current process. The subsequent process wait time is the wait time of the equipment performing the current process between the current process and the immediately subsequent process. Each wait time can be calculated, for example, as the difference between the stoppage end timepoint and the stoppage occurrence timepoint. Therefore, the operating status data including a wait time can be regarded as synonymous with the operating status data including the stoppage occurrence timepoint and the stoppage end timepoint.

Obtainer 13 is a communication interface that communicates with sensors provided in each unit of equipment 12 via a network. Alternatively, obtainer 13 may be the sensor itself provided in each unit of equipment 12.

Inputter 20 accepts operation inputs from a user such as an administrator. Inputter 20 is, for example, any of various input devices such as a keyboard and a mouse. The operation inputs are, for example, an instruction to start anomaly determination, an instruction to start machine learning, an instruction to display determination results, etc. The operation inputs may include designation of production line 11 subject to anomaly determination processing, and designation of a period subject to the anomaly determination processing.

Controller 30 is a processing unit that performs the main processing of the anomaly determination method. Controller 30 includes, for example, a processor such as a central processing unit (CPU), non-volatile memory in which a program is stored, volatile memory that is a temporary storage area for executing the program, and an input/output port. Controller 30 may be a single computer device or a plurality of computer devices connected via a network. The processing executed by controller 30 may, for example, be performed by cloud computing.

As illustrated in FIG. 2, controller 30 includes requester 31, missing data determiner 32, calculator 33, anomaly detector 34, evaluator 35, and output processor 36.

Requester 31 requests storage 50 to transmit operating status data. For example, requester 31 requests transmission of operating status data to be used in the anomaly determination processing based on production line 11 subject to the anomaly determination processing and the target period, which were accepted via inputter 20. Requester 31 also requests missing data determiner 32 to execute processing for determining whether any of the operating status data transmitted from storage 50 was not obtained.

Missing data determiner 32 determines whether any of the operating status data transmitted from storage 50 was not obtained. More specifically, missing data determiner 32 determines whether there is any missing operating status data for a given process based on at least one of the operation timepoint included in the operating status data for the immediately preceding process or the operation timepoint included in the operating status data for the immediately subsequent process. Missing data determiner 32 outputs the determination result of the missing data and the operating status data transmitted from storage 50 to calculator 33.

When it is determined that the operating status data for a given process was not obtained, i.e., when missing data determiner 32 determines that the operating status data for that process is missing, calculator 33 generates dummy operating status data for that process. Hereinafter, a process for which operating status data was not obtained will be referred to as a “missing process”, the process immediately preceding a missing process will be referred to as the “immediately preceding process”, and the process immediately following a missing process will be referred to as the “immediately subsequent process”. The immediately preceding process, the missing process, and the immediately subsequent process are examples of a first process, a second process, and a third process, respectively, and are performed consecutively in this order without any other processes in between.

More specifically, calculator 33 predicts a dummy operation timepoint corresponding to a planned production quantity of the equipment corresponding to the missing process based on at least one of the operating status data of the immediately preceding process or the operating status data of the immediately subsequent process, and generates dummy operating status data that includes the planned production quantity and the dummy operation timepoint. The dummy operation timepoint is a predicted value corresponding to the operation timepoint of the missing process. For example, calculator 33 predicts a dummy operation timepoint corresponding to the operation timepoint of the missing process based on at least one of the operation timepoint of the immediately preceding process or the operation timepoint of the immediately subsequent process.

The dummy operating status data may include, instead of or in addition to the planned production quantity, a dummy wait time. The dummy wait time is a predicted value of the wait time for the missing process. In such cases, calculator 33 predicts a dummy wait time for the missing process based on at least one of the wait time between the immediately preceding process in the equipment that performs the immediately preceding process and the missing process, or the wait time between the missing process and the immediately subsequent process in the equipment that performs the immediately subsequent process.

Calculator 33 generates the dummy operating status data using model data 52 and coefficient data 53 stored in storage 50. A specific example of generating the dummy operating status data will be given later.

Calculator 33 may also generate a machine learning model by executing machine learning. The generated machine learning model is stored in storage 50 as model data 52. Calculator 33 may also calculate coefficients for generating the dummy operating status data by executing machine learning. The calculated coefficients are stored in storage 50 as coefficient data 53.

Anomaly detector 34 performs anomaly determination processing on the production processes as a whole based on the operating status data and dummy operating status data for each process. When there are a plurality of production lines 11, the anomaly determination processing is performed for each production line 11. Stated differently, anomaly detector 34 performs anomaly determination processing on the production processes as a whole, including all processes from the initial process to the final process in production line 11 subject to the processing. More specifically, the anomaly determination processing includes processing that determines presence or absence of an anomaly in the production processes as a whole based on a total production quantity during a total operating time for the entirety of the production processes. For each process among all the production processes, the anomaly determination processing may include processing that determines presence or absence of an anomaly in the process based on a production quantity during an operating time of the process.

The anomaly determination processing may include, in addition to or instead of processing that uses the production quantity, processing that determines presence or absence of an anomaly in the production processes as a whole based on a total wait time in a total operating time for the entirety of the production processes. For each process among all the production processes, the anomaly determination processing may include processing that determines presence or absence of an anomaly in the process based on a wait time in an operating time of the process.

Evaluator 35 performs cause identification processing for identifying the cause of an anomaly by evaluating a result of the anomaly determination processing. More specifically, evaluator 35 identifies production line 11 in which an anomaly is determined to have occurred. Evaluator 35 further identifies, from among all equipment included in production line 11 in which an anomaly is determined to have occurred, the equipment that is anomalous and the cause of the anomaly.

Evaluator 35 may further evaluate the dummy operating status data. More specifically, evaluator 35 evaluates the reliability of the dummy operating status data. The higher the reliability of the dummy operating status data in representing the actual operating status is, the higher the accuracy of the result of the anomaly determination processing is.

Output processor 36 outputs determination result information representing a result of the anomaly determination processing to outputter 40. The result of the anomaly determination processing may include not only that there is an anomaly, but also that there is no anomaly. Output processor 36 may further output an evaluation result by evaluator 35 to outputter 40. For example, output processor 36 may, when outputting the determination result information, output that the anomaly determination processing was performed using the dummy operating status data.

Outputter 40 outputs determination result information representing a result of the anomaly determination processing. More specifically, outputter 40 includes a display such as a liquid crystal display or organic EL display. The display displays the determination result information. An example of what outputter 40 displays will be given later. Outputter 40 may include, in addition to or instead of the display, an audio outputter.

Storage 50 stores information and data necessary for the processing performed by production management system 1. Storage 50 is a non-volatile storage device such as a hard disk drive (HDD) or a solid state drive (SSD). Storage 50 may be a plurality of storage devices connected via a network.

As illustrated in FIG. 2, storage 50 stores production log data 51, model data 52, and coefficient data 53.

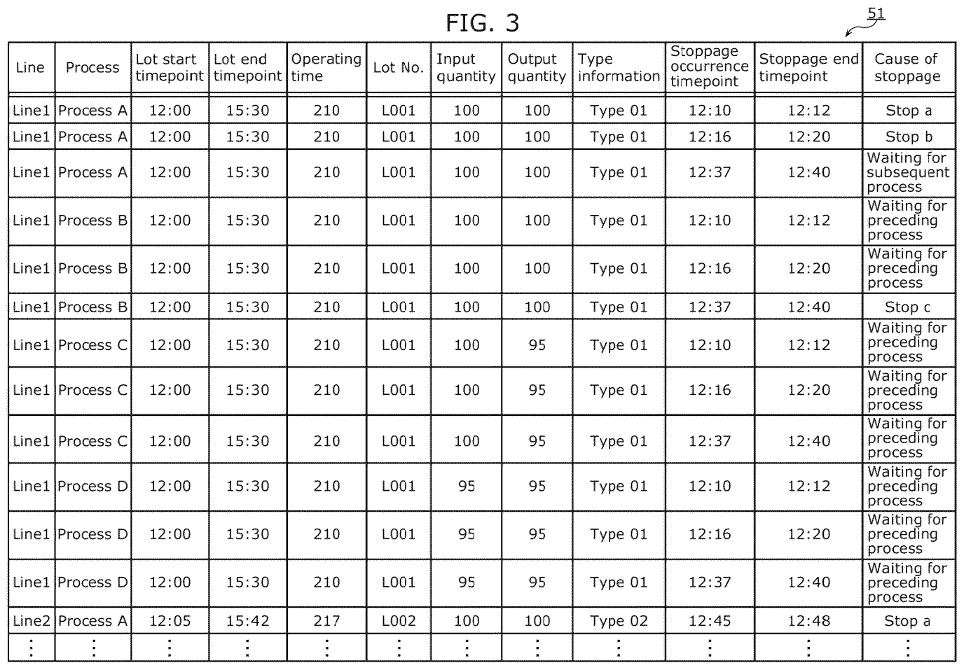

Production log data 51 is a collection of operating status data. FIG. 3 illustrates one example of production log data 51. As illustrated in FIG. 3, production log data 51 includes information on a plurality of items (also called attributes) listed in the top row. More specifically, the plurality of items include production line, process, lot start timepoint, lot end timepoint, operating time, lot number, input quantity, output quantity, type information, stoppage occurrence timepoint, stoppage end timepoint, and cause of stoppage. The plurality of attributes may include the name of the corresponding equipment instead of the process. The quantity and types of items included in production log data 51 are not particularly limited.

Each row of data (also called a record) illustrated in FIG. 3 corresponds to a single stoppage. For example, the records in rows 1 to 3 are data representing the operating status of “process A” of production line 11 “Line1”. The start timepoint of production for the lot with lot number “L001” is “12:00” and the end timepoint is “15:30”. The operating time is “210” minutes. Note that this operating time may be calculated as the difference between the lot end timepoint and the lot start timepoint. The input quantity to the equipment that performs “process A” is “100” units and the output quantity, i.e., the production quantity, is “100” units. Since the input quantity and output quantity are equal, one can tell that all production was performed without any production defects. The product type is “Type 01”.

The record in the first row indicates that during the operating time of “process A” of production line 11 “Line1”, a stoppage occurred at “12:10” due to the cause “Stop a”, and the stoppage ended and production resumed at “12:12”. Similarly, the record in the second row indicates that a stoppage occurred at “12:16” due to the cause “Stop b”, and the stoppage ended and production resumed at “12:20”. The record in the third row indicates that a stoppage occurred at “12:37” due to the cause “waiting for subsequent process”, and the stoppage ended and production resumed at “12:40”. As this shows, three stoppages occurred during the operating time of “process A” of production line 11 “Line1”. The term “waiting for subsequent process” means a stoppage for waiting for processing in the process immediately following the process in question. Similarly, the term “waiting for preceding process” means a stoppage for waiting for processing in the process immediately preceding the process in question.

The operating status data corresponds to records of the same process of the same production line 11. For example, the records in rows 1 to 3 together constitute a single set of operating status data. Alternatively, the operating status data may be regarded as a single record.

Model data 52 includes one or more machine learning models generated by machine learning. The machine learning model is a production model used in anomaly determination processing. The production model is represented, for example, by the type and parameter values of a probability distribution of the production quantity during the total operating time for the entirety of the production processes. The type of probability distributions include normal distribution, log-normal distribution, zero-inflated exponential distribution, gamma distribution, etc. The types of parameters of the probability distribution are determined by the type of probability distribution. For example, in the case of a normal distribution, the parameters are the mean u and the standard deviation σ. The values of the parameters are generated based on past production results, i.e., based on past operating status data.

The one or more machine learning models may include equipment-specific production models represented by the type and parameter values of a probability distribution of the production quantity during the operating time of each unit of equipment. The one or more machine learning models may include cause-specific production models represented by the type and parameter values of a probability distribution of the downtime for each cause of stoppage in the operating time of each unit of equipment. By utilizing at least one of the equipment-specific production models or the cause-specific production models, it is possible to identify the equipment in which an anomaly occurred and the cause of that anomaly.

The one or more machine learning models may include a production model represented by the type and parameter values of a probability distribution of the total wait time in the total operating time for the entirety of the production processes. The production model can be used for anomaly determination processing instead of a production model that is based on production quantity. The one or more machine learning models may include equipment-specific production models represented by the type and parameter values of a probability distribution of the wait time in the operating time of each unit of equipment.

The parameters of the machine learning model can be obtained based on Bayesian estimation. For example, the parameters can be obtained by a sampling method such as Markov chain Monte Carlo (MCMC) simulation, or by variational inference such as the variational Bayesian-expectation maximization (VB-EM) algorithm.

The input data for generating the machine learning model is the operating status data for each process. More specifically, the production quantity and operating time for each process, the downtime (wait time) for each cause, equipment name, and product type are used as input data. The types of input data used to generate the machine learning model are the types of data that should be included in the dummy operating status data. Stated differently, the dummy operating status data does not need to include data of types that were not used to generate the machine learning model.

Coefficient data 53 includes coefficients for generating the dummy operating data. More specifically, coefficient data 53 includes coefficients for calculating the dummy wait time. The coefficients are correction coefficients based on a takt time difference between the missing process and at least one of the immediately preceding process or the immediately subsequent process of the missing process. Stated differently, by utilizing such coefficients, the dummy wait time can be accurately calculated taking into consideration the takt time difference between processes.

The coefficients are calculated by machine learning, but the calculation of the coefficients is not limited to this example. The coefficients may be calculated regressionally. Coefficient data 53 may include coefficients for calculating the dummy operation timepoint and the planned production quantity.

### 3. Production Management System Operations (Anomaly Determination Method)

Next, operations performed by production management system 1, i.e., the anomaly determination method, will be described with reference to the drawings.

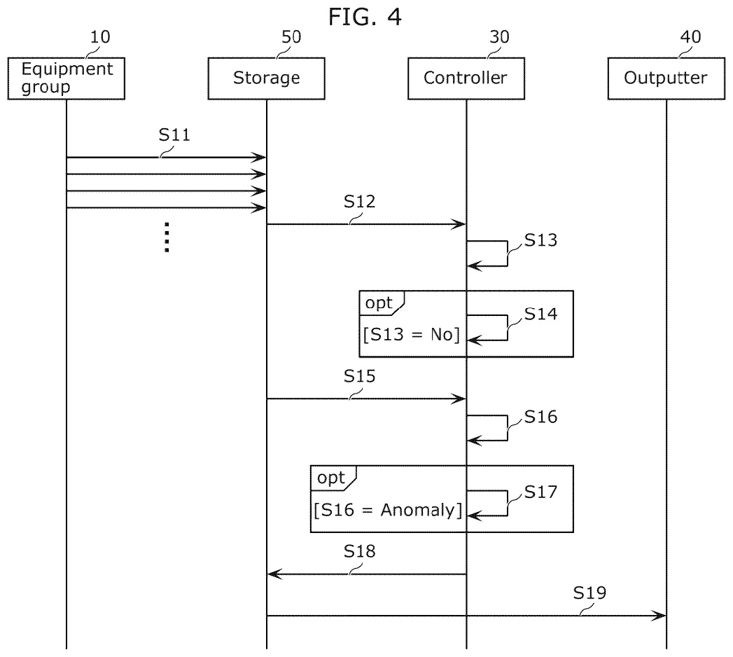

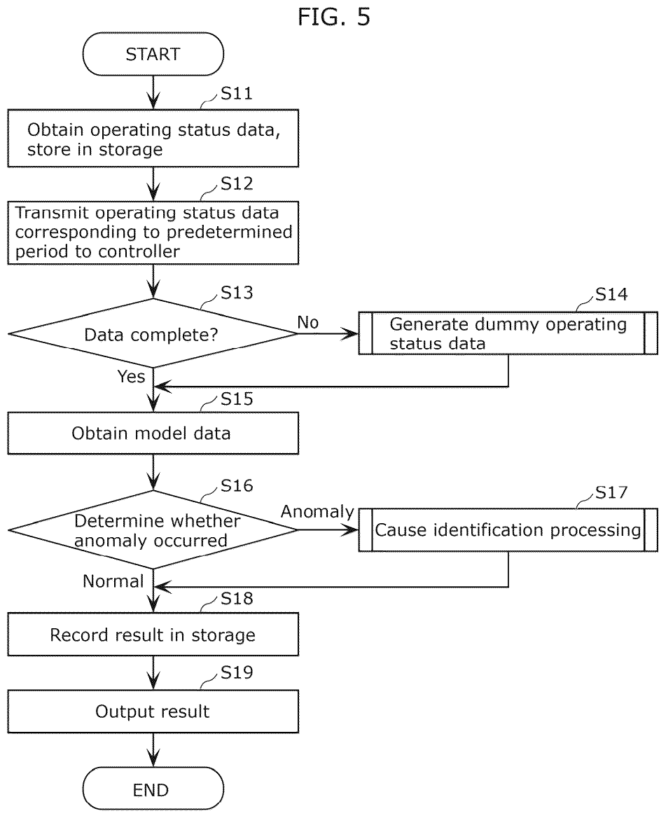

FIG. 4 is a sequence diagram illustrating operations performed by production management system 1 according to the present embodiment. FIG. 5 is a flowchart illustrating operations performed by production management system 1 according to the present embodiment.

As illustrated in FIG. 4 and FIG. 5, first, obtainer 13 obtains operating status data from equipment group 10 and stores the operating status data in storage 50 (S11). The operating status data is obtained from all equipment 12 included in equipment group 10 and accumulated in storage 50.

Next, storage 50 transmits the operating status data corresponding to a predetermined period to controller 30 (S12). The predetermined period is a period subject to the anomaly determination processing and is determined based on an operation input accepted by inputter 20. For example, the predetermined period is a period in which production of one lot was performed, one hour, or one day. When the operation input accepted by inputter 20 specifies a particular production line 11, storage 50 transmits the operating status data of all equipment 12 included in the specified production line 11.

Next, missing data determiner 32 of controller 30 determines whether the operating status data corresponding to the predetermined period that was transmitted is complete (S13). When there is operating status data that has not been obtained, i.e., that is missing (No in S13), calculator 33 of controller 30 generates dummy operating status data (S14).

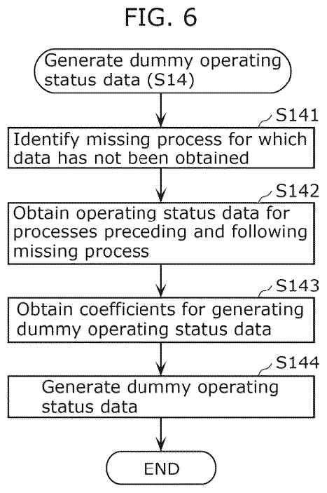

FIG. 6 is a flowchart illustrating a process for generating dummy operating status data (S14).

As illustrated in FIG. 6, calculator 33 identifies the missing process for which operating status data has not been obtained (S141).

Next, calculator 33 obtains the operating status data for the processes preceding and following the missing process (S142). Here, when the missing process is an intermediate process among all the production processes, calculator 33 obtains the operating status data of the immediately preceding process and the operating status data of the immediately subsequent process.

When the missing process is the initial process among all the production processes, calculator 33 obtains the operating status data of the immediately subsequent process, since there is no immediately preceding process. Instead of the operating status data of the immediately preceding process, calculator 33 may obtain initial values such as the production quantity and production start timepoint in the production plan for the target production line 11.

When the missing process is the final process among all the production processes, calculator 33 obtains the operating status data of the immediately preceding process, since there is no immediately subsequent process. Instead of the operating status data of the immediately subsequent process, calculator 33 may obtain final values such as the production quantity and production end timepoint based on the production results of target production line 11.

Next, calculator 33 obtains coefficients for generating the dummy operating status data from storage 50 (S143).

Next, calculator 33 generates the dummy operating status data based on the obtained operating status data and coefficients (S144). For example, calculator 33 predicts a planned production quantity and a dummy operation timepoint, and generates dummy operating status data that includes the predicted planned production quantity and dummy operation timepoint. The planned production quantity is, for example, the production quantity (that is, the output quantity) of the immediately preceding process. Alternatively, the planned production quantity may be the input quantity of the immediately subsequent process. The dummy operation timepoint is an average value of the operation timepoint of the immediately preceding process and the operation timepoint of the immediately subsequent process. Calculator 33 may also predict the dummy wait time. The coefficients obtained in step S143 can be used to predict the dummy wait time.

Through the above processes, production management system 1 generates dummy operating status data corresponding to the missing process.

Returning to FIG. 5, when the operating status data is complete (Yes in S13), or after generating the dummy operating status data, anomaly detector 34 obtains model data 52 (S15). More specifically, anomaly detector 34 obtains a production model of production line 11 subject to the anomaly determination processing. Anomaly detector 34 obtains equipment-specific production models and cause-specific production models of all equipment 12 included in production line 11 subject to the anomaly determination processing.

Next, anomaly detector 34 performs anomaly determination processing (S16). More specifically, anomaly detector 34 calculates an anomaly degree based on the total production quantity during the total operating time obtained from the operating status data including the dummy operating status data. Anomaly detector 34 may calculate an anomaly degree based on the total number of waits in the total operating time obtained from the operating status data including the dummy operating status data.

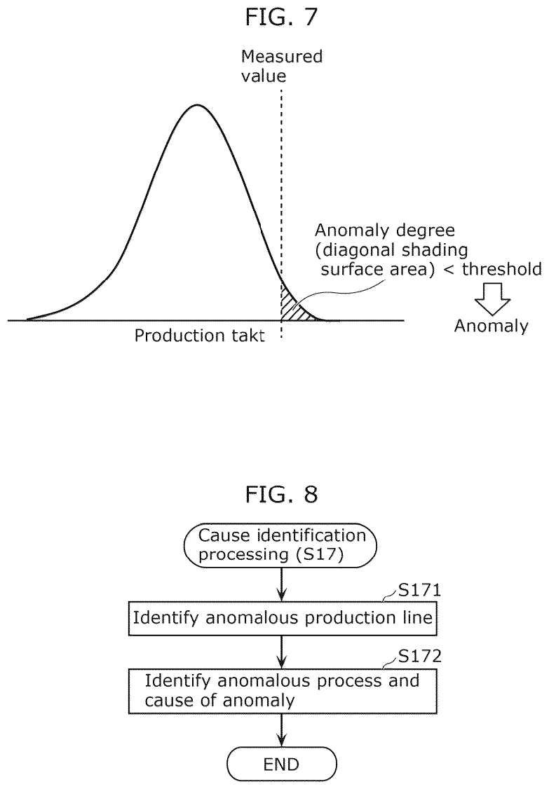

FIG. 7 illustrates the relationship between the trained probability distribution, which is a production model of a single production line, and the anomaly degree. The horizontal axis is, for example, the production tact. The production tact is expressed as total operating time÷total production quantity, or (total operating time−total wait time)÷total production quantity.

The measured value indicated by the dashed line in FIG. 7 is a value of the production tact obtained based on the operating status data for all processes. When an operating status data has not been obtained, the dummy operating status data generated in step S14 is used. The area with diagonal shading in FIG. 7 is the area on the right side of the measured value in the probability distribution, and corresponds to the upper probability, i.e., the anomaly degree. When the upper probability is smaller than the threshold value, it is determined that an anomaly has occurred in production line 11.

Returning to FIG. 5, when it is determined that an anomaly has occurred (“Anomaly” in S16), evaluator 35 performs cause identification processing (S17).

FIG. 8 is a flowchart illustrating cause identification processing for identifying the cause of an anomaly. As illustrated in FIG. 8, evaluator 35 identifies production line 11 that has been determined to be anomalous (S171). Next, evaluator 35 identifies the anomalous process and the cause of the anomaly within the identified production line 11 (S172). More specifically, for each of the plurality of equipment-specific and cause-specific production models, evaluator 35 calculates an upper probability based on actual values, similarly to the anomaly determination processing. When the upper probability is smaller than the threshold value, the equipment and cause corresponding to the production model can be identified as the anomalous process and its cause.

Returning to FIG. 5, when it is determined that an anomaly has not occurred (“Normal” in S16), or after the cause identification processing has ended, controller 30 records the result of the anomaly determination processing and/or the result of the cause identification processing in storage 50 (S18). Next, output processor 36 of controller 30 outputs determination result information representing each result to outputter 40 (S19). For example, a result display image representing the determination result information is generated and displayed in outputter 40.

As described above, in production management system 1 according to the present embodiment, even when operating status data is not obtained, dummy operating status data can be generated and used for anomaly determination processing. The anomaly determination processing utilizes a model generated by machine learning (i.e., a machine learning model), and therefore, conventionally, cannot be executed due to insufficient data. In contrast, according to the present embodiment, anomaly determination processing that could not be executed due to insufficient data can be executed, and a determination result can be obtained.

### 4. Process for Generating Machine Learning Model

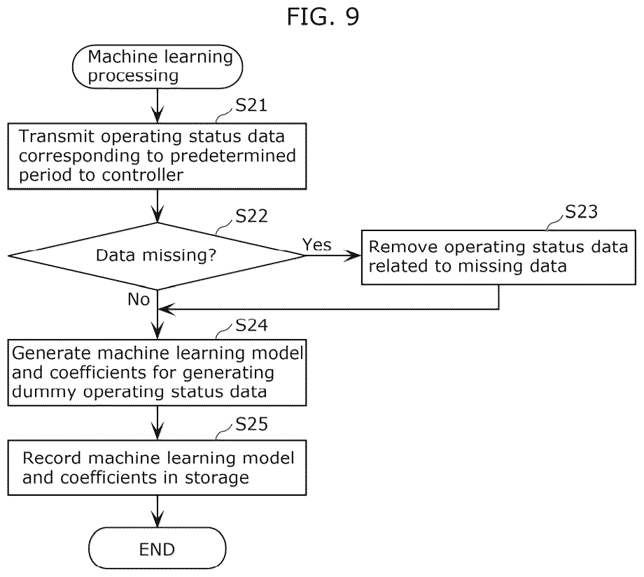

Next, a process for generating a model by machine learning (i.e., a machine learning model) will be described with reference to FIG. 9. FIG. 9 is a flowchart illustrating a process for generating a machine learning model.

As illustrated in FIG. 9, first, storage 50 transmits the operating status data corresponding to a predetermined period to controller 30 (S21). Here, the predetermined period is, for example, a period longer than the predetermined period in step S12 in FIG. 5, and is, for example, a long period such as one day, one week, one month, several months, half a year, or one year.

Missing data determiner 32 of controller 30 determines whether there is any missing data in the operating status data transmitted from storage 50 (S22). When missing data determiner 32 determines that there is missing data (Yes in S22), calculator 33 of controller 30 removes the operating status data related to the missing data (S23). For example, consider a case in which operating status data corresponding to production related to a predetermined lot carried out by equipment 12b_3 in production line 11b in FIG. 1 is missing. In this case, the operating status data related to the production in question, specifically, the operating status data for the other equipment 12 in production line 11b, is removed. Note that the term “remove” means not using the data in generating the machine learning model. Only operating status data for which data is available for all processes is used to generate the machine learning model.

When missing data determiner 32 determines that there is no missing data (No in S22), or after the removal of data has been completed, calculator 33 generates the machine learning model and coefficients for generating the dummy operating status data by machine learning (S24). Next, calculator 33 records the generated machine learning model and coefficients in storage 50 (S25).

Note that the machine learning processing illustrated in FIG. 9 may be performed by a processing unit other than controller 30. Stated differently, production management system 1 may utilize a machine learning model and coefficients generated by another computer device.

### 5. Specific Examples

Next, a plurality of specific examples of generating the dummy operating status data will be given.

### 5-1. First Example

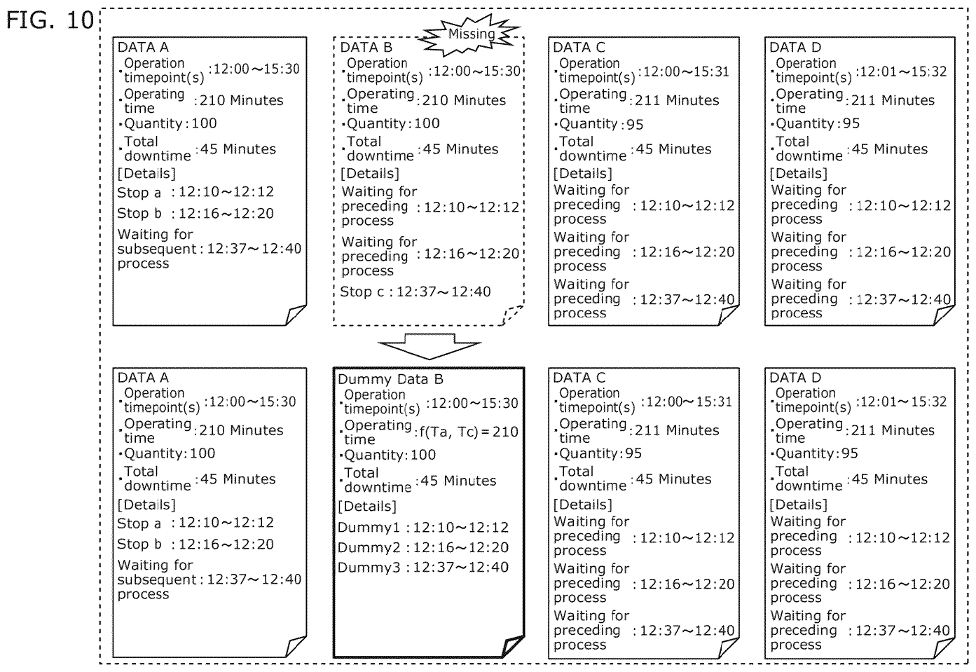

First, an example in which the missing process is an intermediate process will be described with reference to FIG. 10. FIG. 10 illustrates an example of dummy operating status data generated when operating status data of an intermediate process is missing.

In this example, a single production line 11 is composed of four units of equipment, namely equipment A, equipment B, equipment C, and equipment D. Equipment A, equipment B, equipment C, and equipment D are connected by belt conveyors in this order. Equipment A executes process A, which is the initial process. Equipment B executes process B, which is an intermediate process. Equipment C executes process C, which is also an intermediate process. Equipment D executes process D, which is the final process. The operating status data for each of equipment A, equipment B, equipment C, and equipment D are data A, data B, data C, and data D, respectively.

As illustrated in FIG. 10, data A to D each include operation timepoint(s), an operating time, a total downtime during the operating time, and a production quantity. Data A to D each include detailed timepoint information related to the stoppage.

The operation timepoint(s) include, for example, the production start timepoint and production end timepoint of the lot. The operating time is the difference between the production end timepoint and the production start timepoint of the lot. The total downtime is the sum of the downtimes (that is, the wait times) for each stoppage that occurred during the operating time. For example, data A includes a stoppage start timepoint and a stoppage end timepoint for each of the three causes of “Stop a”, “Stop b”, and “waiting for subsequent process”. Although FIG. 10 only illustrates three causes, more stoppages have occurred, and the total time of these stoppages is “45 minutes”. The production quantity is the quantity of products produced by equipment A, i.e., the output quantity of equipment A.

In the example illustrated in FIG. 10, data B is missing and thus could not be obtained. In such cases, calculator 33 of controller 30 generates dummy data B for the missing process based on data A for the immediately preceding process and data C for the immediately subsequent process.

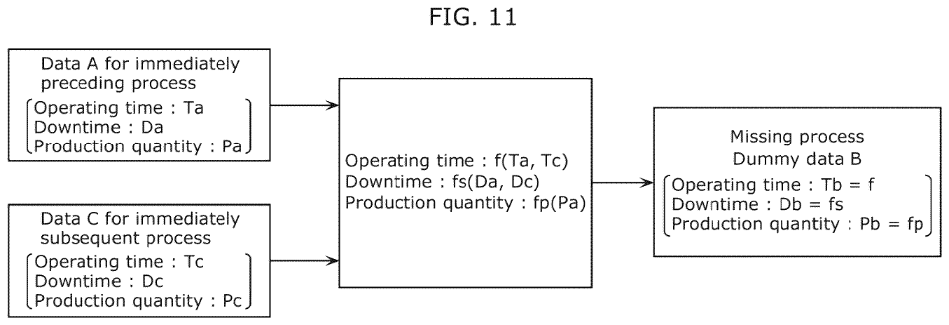

FIG. 11 illustrates input data and output data related to a process for generating dummy operating status data. The input data is data A for the immediately preceding process and data C for the immediately subsequent process. The output data is dummy data B for the missing process.

Let the operating time, downtime, and production quantity in data A for the immediately preceding process be Ta, Da, and Pa, respectively. Let the operating time, downtime, and production quantity in data C for the immediately subsequent process be Tc, Dc, and Pc, respectively. Applying the example of FIG. 10, Ta=210 minutes, Da=45 minutes, Pa=100 units, Tc=211 minutes, Dc=45 minutes, and Pc=95 units. Note that downtimes Da and Dc may be the downtime for each stoppage.

Calculator 33 calculates a predicted value for each of the operating time, the downtime, and the production quantity using functions f(Ta, Tc), fs(Da, Dc), and fp(Pa), respectively. Each function is stored, for example, in a storage (not illustrated) included in controller 30 or in storage 50.

Function f(Ta, Tc) is a function for calculating operating time Tb of dummy data B. More specifically, f(Ta, Tc) is expressed by the following Equation (1).

$$Tb = f ( Ta , Tc ) = Ave ( Ta , Tc ) \qquad ( 1 )$$

Ave ( ) is a function that returns the average value of the values inside the parentheses. Stated differently, operating time Tb of dummy data B is an average value of Ta and Tc. Applying the example of FIG. 10, operating time Tb=210.5 minutes. In FIG. 10, the display of digits after the decimal point is omitted.

Function fs(Da, Dc) is a function for calculating downtime Db of dummy data B. More specifically, fs(Da, Dc) is expressed by the following Equation (2).

$$Db = fs ( Da , Dc ) = min ( Da , Dc ) \times α \qquad ( 2 )$$

min ( ) is a function that returns the minimum value of the values inside the parentheses. α is a coefficient included in coefficient data 53. α is a value determined based on the takt time difference between process A and process B and the takt time difference between process B and process C, and, for example, is a value in a range of greater than or equal to 0.9 and less than or equal to 1.1, but is not limited thereto.

Here, by utilizing the downtime for each stoppage as Da and Dc, a detailed dummy downtime for each stoppage can be calculated. More specifically, the subsequent process wait time is utilized as Da, and the preceding process wait time is utilized as Db. Subsequent process wait time Da of the immediately preceding process A and preceding process wait time Dc of the immediately subsequent process C are each highly likely to be wait times caused by the stoppage of the missing process B. Therefore, by utilizing subsequent process wait time Da of immediately preceding process A and preceding process wait time Dc of immediately subsequent process C, wait time Db of dummy data B can be accurately calculated. For example, referring to the example illustrated in FIG. 10, the first wait time (Dummy1) of dummy data B is calculated based on the preceding process wait time of data C from 12:10 to 12:12.

Function fp(Pa) is a function for calculating a predicted value of the production quantity of dummy data B, i.e., calculating planned production quantity Pb. More specifically, fp(Pa) is expressed by the following Equation (3).

$$Pb = fp ( P a ) = P a \qquad ( 3 )$$

Stated differently, planned production quantity Pb of dummy data B is regarded as being equal to production quantity Pa of immediately preceding process A. This is because all of the products produced in immediately preceding process A can be regarded as having been processed in missing process B.

As described above, when data B is missing, dummy data B is generated. Dummy data B includes the same type of data as the data included in data B. Therefore, dummy data B can be used for anomaly determination processing instead of data B.

Note that the types of data included in dummy data B do not all need to match the types of data included in data B; it is sufficient if dummy data B includes only the types of data that were used in the generating of the machine learning model. For example, if the production quantity is not used in the generating of the machine learning model, dummy data B does not need to include the production quantity. Similarly, if the wait time (downtime) is not used in the generating of the machine learning model, dummy data B does not need to include the wait time.

The above Equations (1) to (3) are merely examples, and are not limited to the above examples. For example, planned production quantity Pb may be production quantity Pc of immediately subsequent process C. Alternatively, planned production quantity Pb may be an average value of Pa and Pc.

### 5-2. Second Example

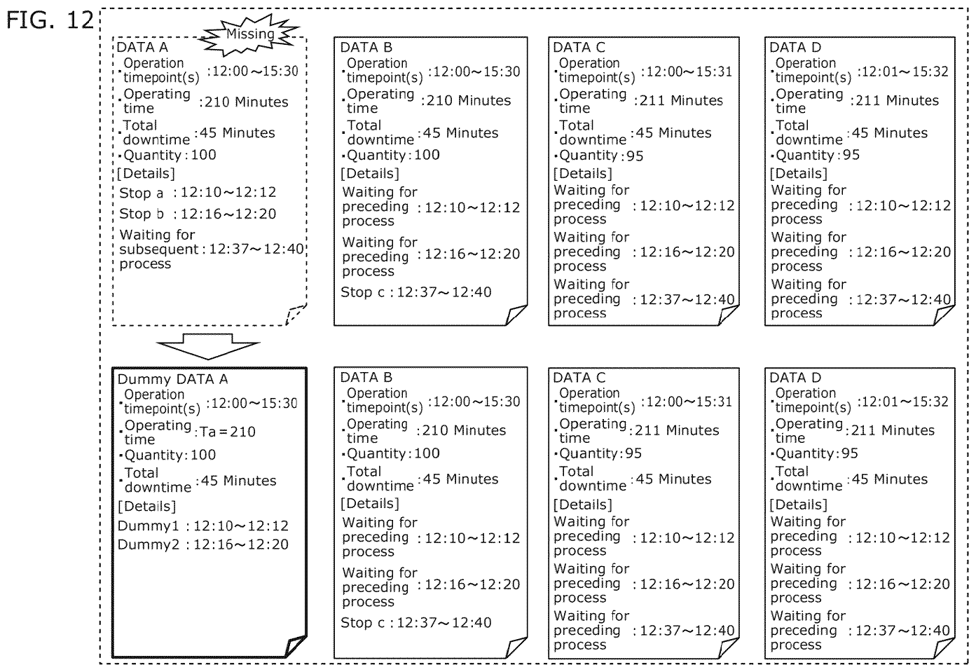

Next, an example in which the missing process is the initial process will be described with reference to FIG. 12. FIG. 12 illustrates an example of dummy operating status data generated when operating status data for the initial process is missing. In the following description, the explanation will focus on the differences from the first example, and description of points in common will be omitted or simplified.

In the example illustrated in FIG. 12, data A for the initial process is missing and could not be obtained. In such cases, calculator 33 of controller 30 generates dummy data A for the missing process based on data B for the immediately subsequent process, since there is no data for the process immediately preceding the missing process.

More specifically, the functions for calculating a predicted value for each of the operating time, the downtime, and the production quantity can be expressed as f(Tb), fs(Db), and fp(Pb), respectively, using operating time Tb, downtime Db, and production quantity Pb of data B for the immediately subsequent process as variables. In such cases, operating time Ta, downtime Da, and production quantity Pa of dummy data A for the missing process can be expressed by the following Equations (4) to (6).

$$Ta = f ( Tb ) = Tb \qquad ( 4 )$$

$$Da = fs ( Db ) = Db \times β \qquad ( 5 )$$

$$P a = fp ( Pb ) = Pb \qquad ( 6 )$$

In Equation (5), β is a coefficient generated by machine learning or the like, similar to α in Equation (2). Similar to the first example, downtime Da can be calculated for each stoppage. Calculator 33 can generate dummy data A as illustrated in FIG. 12 by utilizing the above Equations (4) to (6).

The above Equations (4) to (6) are merely examples, and are not limited to the above examples. For example, in addition to data B of the immediately subsequent process, initial values based on the production plan may also be utilized. For example, planned production quantity Pa may be the planned production quantity defined by the production plan.

### 5-3. Third Example

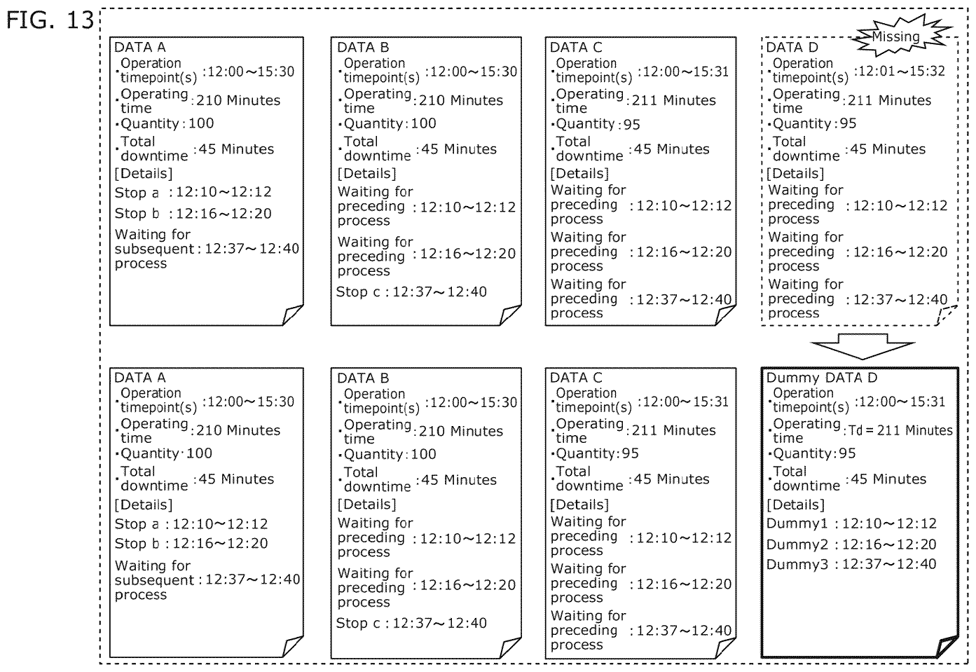

Next, an example in which the missing process is the final process will be described with reference to FIG. 13. FIG. 13 illustrates an example of dummy operating status data generated when operating status data for the final process is missing. In the following description, the explanation will focus on the differences from the first example, and description of points in common will be omitted or simplified.

In the example illustrated in FIG. 13, data D for the final process is missing and could not be obtained. In such cases, calculator 33 of controller 30 generates dummy data D for the missing process based on data C for the immediately preceding process, since there is no data for the process immediately following the missing process.

More specifically, the functions for calculating a predicted value for each of the operating time, the downtime, and the production quantity can be expressed as f(Tc), fs(Dc), and fp(Pc), respectively, using operating time Tc, downtime Dc, and production quantity Pc of data C for the immediately preceding process as variables. In such cases, operating time Td, downtime Dd, and production quantity Pd of dummy data D for the missing process can be expressed by the following Equations (7) to (9).

$$Td = f ( Tc ) = Tc \qquad ( 7 )$$

$$Dd = fs ( Dc ) = Dc \times γ \qquad ( 8 )$$

$$Pd = fp ( Pc ) = Pc \qquad ( 9 )$$

In Equation (8), y is a coefficient generated by machine learning or the like, similar to a in Equation (2). Similar to the first example, downtime Dd can be calculated for each stoppage. Calculator 33 can generate dummy data D as illustrated in FIG. 13 by utilizing the above Equations (7) to (9).

The above Equations (7) to (9) are merely examples, and are not limited to the above examples. For example, in addition to data C of the immediately preceding process, final values based on the final production results may also be utilized. For example, planned production quantity Pd may be the quantity actually produced on production line 11.

### 5-4. Fourth Example

The first to third examples described above are all cases where the operating status data that was supposed to be obtained is missing. In contrast, there are also cases where, due to reasons such as equipment issues, the operating status data is not planned to be obtained from the outset. Dummy operating status data can be generated in such cases as well.

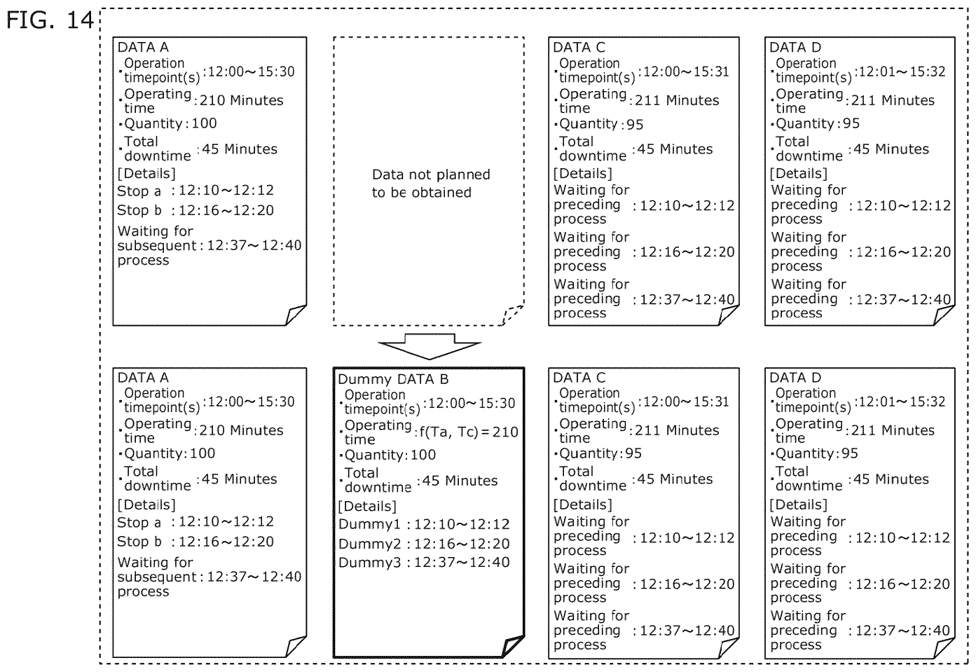

FIG. 14 illustrates an example of dummy operating status data generated in place of operating status data that is not planned to be obtained. In the following description, the explanation will focus on the differences from the first example, and description of points in common will be omitted or simplified.

The example illustrated in FIG. 14 is the same as the first example in that the operating status data is not obtained, with the only difference being whether the unobtained operating status data is data that was supposed to be obtained or data that was not planned to be obtained from the outset. Therefore, similar to the first example, dummy data B can be generated based on Equations (1) to (3).

In the case of the fourth example, the processing for determining whether there is missing (unobtained) operating status data (step S13 in FIG. 5) can be omitted. Since it is known in advance which equipment's operating status data is not planned to be obtained, the system can be set in advance to generate dummy operating status data for that equipment.

Note that while the fourth example describes a case where data for an intermediate process is not planned to be obtained, in cases where data for the initial process or the final process is not planned to be obtained, dummy operating status data can be generated by performing processing similar to the second or third example.

### 6. Display Examples

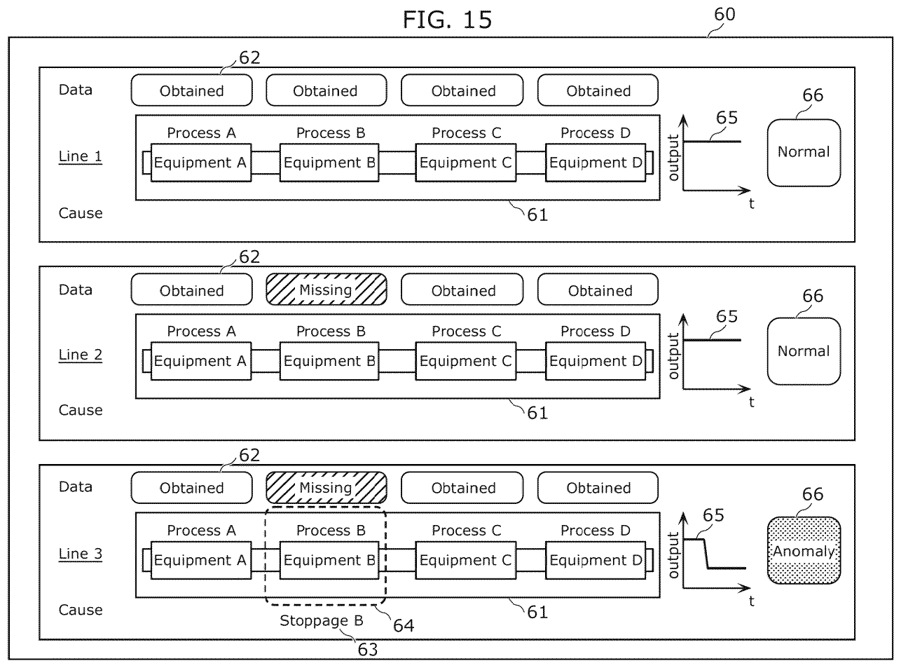

Next, examples of displaying determination results in production management system 1 will be described with reference to FIG. 15. FIG. 15 illustrates examples of displaying determination results in production management system 1 according to the present embodiment.

FIG. 15 illustrates display screen 60 showing anomaly determination processing results for three production lines 1 to 3. Each production line includes four units of equipment A to D in this order.

Display screen 60 includes schematic diagram 61 illustrating the configuration of the production line. Icons 62 indicating whether operating status data was obtained or not are displayed above schematic diagram 61. Text 63 indicating the cause of the anomaly is displayed below schematic diagram 61. Text 63 is not displayed when there is no anomalous equipment (process). Dashed frame 64 is displayed around the anomalous equipment. This makes it possible to emphatically and clearly display the anomalous equipment. On the right side of schematic diagram 61, graph 65 showing the anomaly determination results of the production line in time series and icon 66 indicating the presence or absence of an anomaly are displayed.

In the display example illustrated in FIG. 15, one can see that in production line 1, there is no missing operating status data and no anomaly occurred. However, in production line 2, one can see that while there was missing operating status data for equipment B, the production itself was completed without any anomalies. Icon 62 indicates that operating status data was missing, so the user can be prompted to perform an inspection such as checking the network related to obtainment of the operating status data.

In production line 3, one can see that not only was there missing operating status data for equipment B, but that an anomaly also occurred in the production and the cause of that anomaly was “stoppage B” that occurred in equipment B. Displaying the occurrence of an anomaly makes it possible to prompt the user to perform maintenance work. Displaying the cause of the anomaly makes it possible to show which specific target equipment needs maintenance work and the details of the work. This increases the work efficiency of maintenance work and shortens the downtime of the equipment, which in turn improves production efficiency.

Note that the display example illustrated in FIG. 15 is merely an example, and is not particularly limited. For example, instead of displaying schematic diagram 61, only icons 66 indicating whether each production line is anomalous or normal (not anomalous) may be displayed. Icons 62 indicating the obtainment status of the operating status data, text 63 indicating the cause of the anomaly, and frame 64 indicating the anomalous equipment need not be displayed.

Instead of frame 64, the anomalous equipment may be drawn with a thick line or displayed blinking.

### OTHER EMBODIMENTS

Hereinbefore, the anomaly determination method and the production management system according to one or more aspects have been described based on embodiments, but the present disclosure is not limited to these embodiments. Various modifications to the present embodiment that may be conceived by those skilled in the art, as well as embodiments resulting from combinations of elements from different embodiments, are intended to be included within the scope of the present disclosure as long as these do not depart from the essence of the present disclosure.

For example, in the above embodiment, two cases were described, namely a case where anomaly determination processing is performed using the production quantity of the equipment and a case where anomaly determination processing is performed using the wait time in the equipment, but both cases may be performed, or only one may be performed. In cases in which both are performed, an anomaly can be determined to have occurred when an anomaly has been determined to occurred in at least one of them.

In cases in which only one is performed, this reduces the amount of information included in the operating status data, and decreases the data volume. For example, if the production quantity of the equipment is used, the operating status data does not need to include the wait time. If the wait time of the equipment is used, the operating status data does not need to include the production quantity.

The communication method between devices described in the above embodiment is not particularly limited. In cases in which wireless communication is performed between devices, the wireless communication method (communication standard) is, for example, short-range wireless communication such as ZigBee (registered trademark), Bluetooth (registered trademark), or wireless local area network (LAN). Alternatively, the wireless communication method (communication standard) may be communication via a wide area communication network such as the Internet. Wired communication may be performed between devices instead of wireless communication. More specifically, wired communication is communication using power line communication (PLC) or wired LAN.

In the above embodiment, processing performed by a particular processing unit may be performed by a different processing unit. The order of the plurality of processes may be changed, or the plurality of processes may be executed in parallel. In the above embodiment, the allocation of elements of the production management system to the devices is merely one example. For example, an element included in one device may be included in another device. The production management system may also be implemented as a single device.

For example, the processing described in the above embodiment may be realized by centralized processing using a single device (system), or may be realized by distributed processing using a plurality of devices. The processor that executes the program described above may be a single processor or a plurality of processors. Stated differently, the processing may be centralized or distributed.

In the above embodiment, all or part of the elements such as the controller may be configured using dedicated hardware, or may be implemented by executing a software program suitable for each element. Each element may be implemented by a program execution unit such as a CPU or processor reading and executing a software program recorded on a recording medium such as an HDD or semiconductor memory.

The elements such as the controller may be configured of one or more electronic circuits. The one or more electronic circuits may each be a general-purpose circuit or a dedicated circuit.

The one or more electronic circuits may include, for example, a semiconductor device, an integrated circuit (IC), or a large scale integrated (LSI) circuit. The IC or LSI circuit may be integrated on a single chip, or may be integrated on a plurality of chips. Although these circuits are referred to as IC or LSI circuit here, the terminology may change depending on the degree of integration, and these circuits may be called system LSI circuit, a very large scale integrated (VLSI) circuit, or an ultra large scale integrated (ULSI) circuit. A field programmable gate array (FPGA) that is programmed after manufacturing the LSI circuitry can be used for the same purpose.

General or specific aspects of the present disclosure may be realized as a system, an apparatus or device, a method, an integrated circuit, or a computer program. Alternatively, the computer program may be realized on a non-transitory computer-readable recording medium such as an optical disc, an HDD, or semiconductor memory. Any given combination of a system, an apparatus or device, a method, an integrated circuit, a computer program, and a recording medium may be used to realize the aspects.

Various changes, substitutions, additions, omissions, etc., can be made to each of the above embodiments within the scope of the claims or their equivalents.

### INDUSTRIAL APPLICABILITY

The present disclosure is applicable, for example, in management systems and anomaly determination devices at production sites such as factories.

1. An anomaly determination method in a production management system that manages a production line including a first production device corresponding to a first process, a second production device corresponding to a second process following the first process, and a third production device corresponding to a third process following the second process, the anomaly determination method comprising:
from among (i) first operating status data including a first production quantity of the first production device and a first operation timepoint corresponding to each production in the first production device, (ii) second operating status data including a second production quantity of the second production device and a second operation timepoint corresponding to each production in the second production device, and (iii) third operating status data including a third production quantity of the third production device and a third operation timepoint corresponding to each production in the third production device, obtaining at least (i) the first operating status data and (iii) the third operating status data via a network;
when it is determined that the second operating status data was not obtained based on the first operation timepoint and the third operation timepoint, predicting a dummy operation timepoint corresponding to a planned production quantity of the second production device based on the first operating status data and the third operating status data, and generating dummy operating status data that corresponds to the second operating status data and includes the planned production quantity and the dummy operation timepoint;
based on the first operating status data, the third operating status data, and the dummy operating status data, performing anomaly determination processing on production processes, including processes from the first process to the third process, as a whole; and
outputting determination result information to display the determination result information on a display device included in the production management system, the determination result information representing a result of the anomaly determination processing.

2. The anomaly determination method according to claim 1, wherein
the outputting of the determination result information includes outputting that the anomaly determination processing was performed using the dummy operating status data in the second process.

3. The anomaly determination method according to claim 1, wherein
the anomaly determination processing determines presence or absence of an anomaly in the production processes as a whole based on a total production quantity during a total operating time for an entirety of the production processes.

4. The anomaly determination method according to claim 1, wherein
for each process among all the production processes, the anomaly determination processing determines presence or absence of an anomaly in the process based on a production quantity during an operating time of the process.

5. The anomaly determination method according to claim 1, wherein
the result of the anomaly determination processing includes that there is no anomaly in the production processes.

6. The anomaly determination method according to claim 1, wherein
the first production device, the second production device, and the third production device are connected by a belt conveyor in the production line.

7. A production management system that manages a production line including a first production device corresponding to a first process, a second production device corresponding to a second process following the first process, and a third production device corresponding to a third process following the second process, the production management system comprising:
from among (i) first operating status data including a first production quantity of the first production device and a first operation timepoint corresponding to each production in the first production device, (ii) second operating status data including a second production quantity of the second production device and a second operation timepoint corresponding to each production in the second production device, and (iii) third operating status data including a third production quantity of the third production device and a third operation timepoint corresponding to each production in the third production device, obtaining at least (i) the first operating status data and (iii) the third operating status data via a network;
when it is determined that the second operating status data was not obtained based on the first operation timepoint and the third operation timepoint, predicting a dummy operation timepoint corresponding to a planned production quantity of the second production device based on the first operating status data and the third operating status data, and generating dummy operating status data that corresponds to the second operating status data and includes the planned production quantity and the dummy operation timepoint;
based on the first operating status data, the third operating status data, and the dummy operating status data, performing anomaly determination processing on production processes, including processes from the first process to the third process, as a whole; and
outputting determination result information to display the determination result information on a display device included in the production management system, the determination result information representing a result of the anomaly determination processing.

8. An anomaly determination method in a production management system that manages a production line including a first production device corresponding to a first process, a second production device corresponding to a second process following the first process, and a third production device corresponding to a third process following the second process, the anomaly determination method comprising:
obtaining, via a network, (i) first operating status data including a first production quantity of the first production device and a first operation timepoint corresponding to each production in the first production device and (ii) third operating status data including a third production quantity of the third production device and a third operation timepoint corresponding to each production in the third production device;
predicting a dummy operation timepoint corresponding to a planned production quantity of the second production device based on the first operating status data and the third operating status data, and generating dummy operating status data including the planned production quantity and the dummy operation timepoint;
based on the first operating status data, the third operating status data, and the dummy operating status data, performing anomaly determination processing on production processes, including processes from the first process to the third process, as a whole; and
outputting determination result information to display the determination result information on a display device included in the production management system, the determination result information representing a result of the anomaly determination processing.

9. The anomaly determination method according to claim 8, wherein
the outputting of the determination result information includes outputting that the anomaly determination processing was performed using the dummy operating status data in the second process.

10. A production management system that manages a production line including a first production device corresponding to a first process, a second production device corresponding to a second process following the first process, and a third production device corresponding to a third process following the second process, the production management system comprising:
obtaining, via a network, (i) first operating status data including a first production quantity of the first production device and a first operation timepoint corresponding to each production in the first production device and (ii) third operating status data including a third production quantity of the third production device and a third operation timepoint corresponding to each production in the third production device;
predicting a dummy operation timepoint corresponding to a planned production quantity of the second production device based on the first operating status data and the third operating status data, and generating dummy operating status data including the planned production quantity and the dummy operation timepoint;
based on the first operating status data, the third operating status data, and the dummy operating status data, performing anomaly determination processing on production processes, including processes from the first process to the third process, as a whole; and
outputting determination result information to display the determination result information on a display device included in the production management system, the determination result information representing a result of the anomaly determination processing.

11. An anomaly determination method in a production management system that manages a production line including a first production device corresponding to a first process and a second production device corresponding to a second process, the second process being a final process and following the first process, the anomaly determination method comprising:
from among (i) first operating status data including a first production quantity of the first production device and a first operation timepoint corresponding to each production in the first production device and (ii) second operating status data including a second production quantity of the second production device and a second operation timepoint corresponding to each production in the second production device, obtaining at least the first operating status data via a network;
when it is determined that the second operating status data was not obtained based on the first operation timepoint, predicting a dummy operation timepoint corresponding to a planned production quantity of the second production device based on the first operating status data, and generating dummy operating status data that corresponds to the second operating status data and includes the planned production quantity and the dummy operation timepoint;
based on the first operating status data and the dummy operating status data, performing anomaly determination processing on production processes, including the first process and the second process, as a whole; and
outputting determination result information to display the determination result information on a display device included in the production management system, the determination result information representing a result of the anomaly determination processing.

12. The anomaly determination method according to claim 11, wherein
the outputting of the determination result information includes outputting that the anomaly determination processing was performed using the dummy operating status data in the second process.

13. An anomaly determination method in a production management system that manages a production line including a first production device corresponding to a first process and a second production device corresponding to a second process following the first process, the first process being an initial process, the anomaly determination method comprising:
from among (i) first operating status data including a first production quantity of the first production device and a first operation timepoint corresponding to each production in the first production device and (ii) second operating status data including a second production quantity of the second production device and a second operation timepoint corresponding to each production in the second production device, obtaining at least the second operating status data via a network;
when it is determined that the first operating status data was not obtained based on the second operation timepoint, predicting a dummy operation timepoint corresponding to a planned production quantity of the first production device based on the second operating status data, and generating dummy operating status data that corresponds to the first operating status data and includes the planned production quantity and the dummy operation timepoint;
based on the dummy operating status data and the second operating status data, performing anomaly determination processing on production processes, including the first process and the second process, as a whole; and
outputting determination result information to display the determination result information on a display device included in the production management system, the determination result information representing a result of the anomaly determination processing.

14. The anomaly determination method according to claim 13, wherein
the outputting of the determination result information includes outputting that the anomaly determination processing was performed using the dummy operating status data in the first process.

15. A non-transitory computer-readable recording medium having recorded thereon a program for causing a computer to execute the anomaly determination method according to claim 1.

16. A non-transitory computer-readable recording medium having recorded thereon a program for causing a computer to execute the anomaly determination method according to claim 8.

17. A non-transitory computer-readable recording medium having recorded thereon a program for causing a computer to execute the anomaly determination method according to claim 11.

18. A non-transitory computer-readable recording medium having recorded thereon a program for causing a computer to execute the anomaly determination method according to claim 13.
